(19) United States
(12) Patent Application Publication
(10) Pub. No.: US 2006/0250815 A1
(43) Pub. Date: Nov. 9, 2006

(54) Mine lighting device

(76) Inventors: Sebastian M. Mundry, Ludinghausen (DE); Frank Leveque-Emden, Schwerte (DE); Jürgen Tschöpe, Selm (DE); Jens Titschert, Lünen (DE)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/558,107

(22) PCT Filed: May 17, 2004
(86) PCT No.: PCT/EP04/05280

§ 371 Date: Jul. 14, 2006

(30) Foreign Application Priority Data
May 23, 2003 (DE) 103237798

(51) Int. Cl. B64D 47/06

(52) U.S. Cl. 362/559

(57) ABSTRACT

The invention concerns a mining lamp 1 with a signal display. The mining lamp 1 is characterised in that it includes a large number of light diodes 3 and a control device 9, by means of which the light diodes 3 can be controlled individually or in groups, in order to display symbols, flashing signals, letters, text, patterns and/or similar.

The invention concerns a mining lamp or pit lamp with a signal display.

A lamp of this type for the illumination of longwall faces or similar in mines is known art from DE 80 18 413 U1. The lamp disclosed in that patent comprises a fluorescent lamp and a flash lamp for the transmission of signals, where a base for the flash lamp and a base for the fluorescent lamp are cast together in a common plastic mass in a casing. To fulfil the conditions for the prevention of gas explosions in coal mining, the lamp tubes of the two lamps are embedded in a transparent cast mass. Such a pressure-tight design for the lamp casings is complicated and cost intensive.

Due to the use of energy-saving tubes in the mining lamps, the energy costs for operation of the lamps could be clearly reduced, but there still exists a need for lamps with lower energy consumption.

Energy-saving tubes or fluorescent tubes have the disadvantage that reactive power compensation and ballasts, such as for example ignition units for the production of an ignition voltage, are required for their operation. Furthermore, ignition units must be investigated and designed with regard to their electromagnetic compatibility.

Although the life of fluorescent tubes is clearly higher than that of conventional incandescent bulbs, it is limited to approximately 10,000 hours. The replacement of defective fluorescent tubes is time-consuming and contributes significantly to the maintenance expense for the lamps that are fitted with fluorescent tubes.

Object of this invention therefore is to provide a mining lamp, which can be produced and operated cost-effectively, and which fulfils the conditions that must be met in mining, in particular with regard to explosion proof.

The object is achieved in that the lamp includes a large number of light diodes, or light emitting diodes (LED), and a control device, by means of which the light diodes can be controlled individually or in groups to display symbols, flashing signals, letters, text, patterns and/or similar.

In accordance with the invention the control device, which can include a microprocessor, receives an input signal or a sequence of input signals. In accordance with these inputs the control device controls the light diodes individually or in groups. A simple means of control consists in interrupting the current flow to all light diodes at the same time and then restoring the current flow, so that the light diodes flash in concert and generate an integrated flashing light. A more elaborate means of control consists in allowing the light diodes located in a certain spatial arrangement to light up individually or in groups, thereby generating a pattern or a symbol. Also by means of a time-dependent means of control a direction of movement, or a sequence of patterns or signals, can be represented. In this manner the lamp in accordance with the invention is not limited to one or a few displays, but can transmit a range of information to the miner.

Because of the low operating voltage of the light diodes the mining lamp constitutes an intrinsically safe lamp. Since no pressure-tight casing is necessary, significant costs can be saved in the casing design.

The life of standard light diodes is 100,000 hours and more, and thus is significantly higher than that of fluorescent lamps. Maintenance servicing and lamp replacement are practically no longer necessary. The light diode exhibits a further advantage compared with conventional lamps: since the light emission does not end abruptly, but decreases slowly with time, notice of the failure of the light diode is slowly given, so that it can be replaced before total failure.

Because of the high efficiency of light diodes the energy consumption is very low, as a result of which the generation of heat by the lamp can be kept low. The lower light intensity in comparison with fluorescent tubes can be compensated for by the use of a larger number of light diodes and/or by the use of extremely bright light diodes.

The light diodes are preferably arranged on a level surface area. The separation between the light diodes can be equal throughout, so that the light diodes produce a light intensity that is approximately even over the surface area.

The light diodes are preferably arranged in a regular pattern, which is preferably symmetrical. This includes also rotationally symmetrical arrangements, in which the light diodes can be arranged on one circle or on concentric circles.

In a preferred embodiment the light diodes are arranged in the form of a matrix. This means that the diodes are arranged in rows and columns. This form of arrangement includes also the arrangement of the light diodes in only one column or in only one row. By means of a matrix type of arrangement it is, in particular, possible to populate a rectangular surface area evenly with light diodes.

The light diodes can be arranged on a rectangular surface area of approximately 150×150 mm, such that the light diodes are arranged in seven to eight rows and columns. The light diodes thereby exhibit a separation distance from each other of approximately 20 mm. An arrangement of this type leads to a good surface area illumination. Because of the high number of light diodes (64, for example, in the case of a fully populated matrix with eight rows and 8 columns) it is possible to achieve a total light intensity comparable with that of conventional lamps. A further advantage of an arrangement in matrix form consists in the fact that symbols, numbers, etc can be well represented.

In order to be able to illuminate a space or a surface area in accordance with particular demands with the mining lamp in accordance with the invention, the main direction of radiation for at least two light diodes can be different. As a rule a light diode exhibits a rotationally symmetrical light distribution. The main direction of radiation thereby corresponds to the direction of the axis of symmetry of the light distribution. Since a light diode radiates light in different directions with different intensity the light of the mining lamp can be focused or fanned out by the selection of different main directions of radiation for the light diodes. Light diodes with a radiation angle of 50 to 60° are preferably used. With light diodes radiating in different directions any pattern of illumination can be produced in an advantageous manner.

In a preferred example of embodiment at least two light diodes emit light of different colours. So for example for purposes of illumination one group of light diodes can emit white light, while another group generates yellow, blue, red or green light in order to display a coloured symbol. In this manner the coloured filters of known art from conventional lamps are no longer necessary for the display of coloured symbols. This keeps the manufacturing costs of the mining lamp in accordance with the invention low. Moreover higher efficiencies can be achieved, since the light is not attenuated by coloured filters.

In a lamp in accordance with the invention light diodes that generate light of different intensities can also be used to advantage. On the one hand this can thereby influence not only the spatial arrangement of the light diodes, but also the illumination of the space or surface area to be illuminated. On the other hand it is also possible to represent patterns, symbols etc by means of light diodes of differing intensity.

The control device can preferably generate a scrolling text, in which three alphanumeric symbols can preferably be represented at the same time. With a simultaneous display of three symbols the scrolling script is easy to read, while the number of light diodes required in order to be able to represent these three symbols at the same time is not too high.

In a preferred example of embodiment the mining lamp is operated with a voltage of 12 volts. With this operating voltage it is not necessary for the lamp casing to be designed to be pressure tight for adherence to regulations with regard to protection against explosions, which keeps the manufacturing costs low. Moreover a 12 volt supply in mining can be made available in a relatively cost-effective manner. A low voltage of 5 or 24 volts is also possible.

A number of light diodes, preferably three, are preferably electrically connected together in series, since the operating voltages or forward voltages of conventional light diodes are 2 to 4 volts. Since the typical forward voltage of white light diodes (light diodes that emit white light) is 3.6 volts, a voltage drop of 10.8 volts would be produced in the event that three white light diodes are connected together in series, which compared with a voltage of 12 volts leads to a residual voltage swing of less than 2 volts.

A current regulator circuit including a series regulator and a resistance can be inserted ahead of the light diodes that are connected in series. This current regulator circuit dissipates any residual voltage swing in the circuit leg of the light diodes connected together in series, and stabilises the supply current per series connection. The supply current per circuit leg is preferably 20 mA. However, light diodes can also be used, whose operating current is clearly higher, so that the supply current per circuit leg is correspondingly higher. Furthermore protection against polarity switching can be provided in order to prevent an incorrectly applied voltage from destroying the light diodes.

In a preferred embodiment the current for the mining lamp is approximately 360 mA. By using conventional light diodes with a forward current of 20 mA, there will be 18 circuit legs connected in parallel in the mining lamp. Assuming three light diodes per circuit leg, the mining lamp includes 54 light diodes.

Furthermore the mining lamp, for control of the LEDs and for transmission of the information, symbols or signals represented with the LEDs, preferably can be connected or is connected to a preferably bi-directional communication circuit, in particular a digital communication circuit, or a bus. Via the digital communication circuit or the bus the operating mode, or the signals or information to be represented, can be transmitted to the mining lamp in a simple manner. The bus can be a two-wire bus that is coupled via a galvanically isolating module to a serial interface of a longwall face control system. Furthermore it is advantageous if the mining lamp, preferably its control device, is fitted with a microcontroller (MCU), or a microcontroller is assigned to it. The microcontroller (MCU) can, e.g., independently evaluate and process control commands arriving via the bus or the digital communication circuit, using the matched functionalities integrated in the MCU, and can thus also drive the sequences of signal displays on the basis of particular control commands. The microcontroller enables furthermore feedback concerning the status of the mining lamp and the LEDs as well as of the signal or information displays executed, whereby a remote diagnosis of each mining lamp is possible by the above-ground longwall face control centre.

On the basis of the embodiment example represented in the figures the invention is now described in more detail. In these:

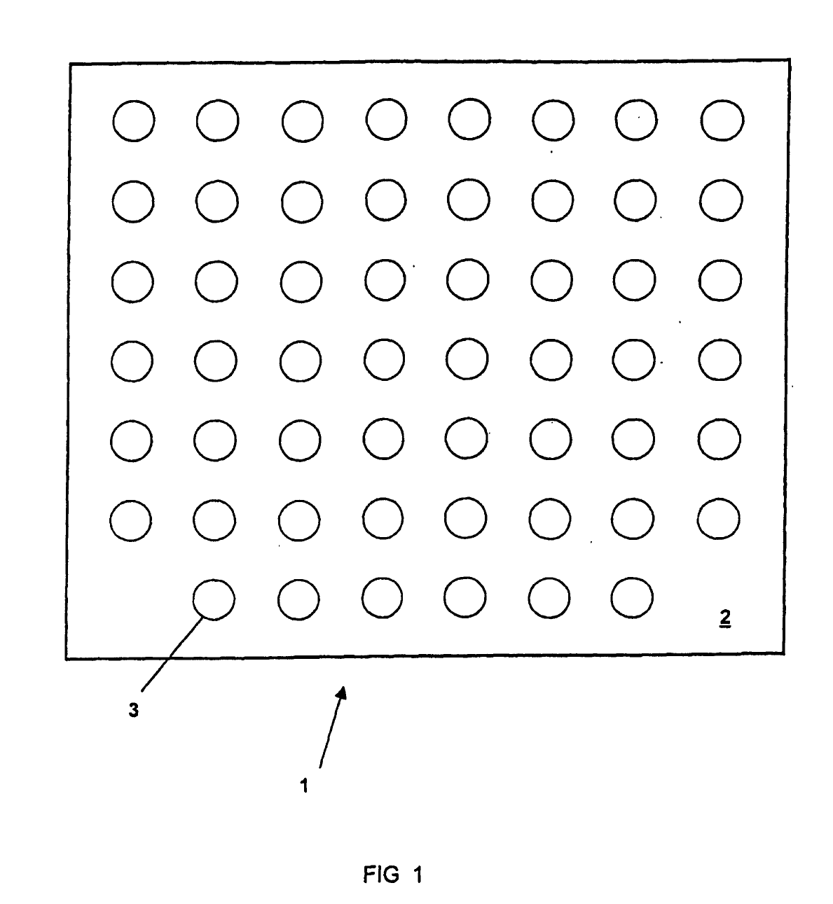

FIG. 1 shows a front view of a mining lamp in accordance with the invention;

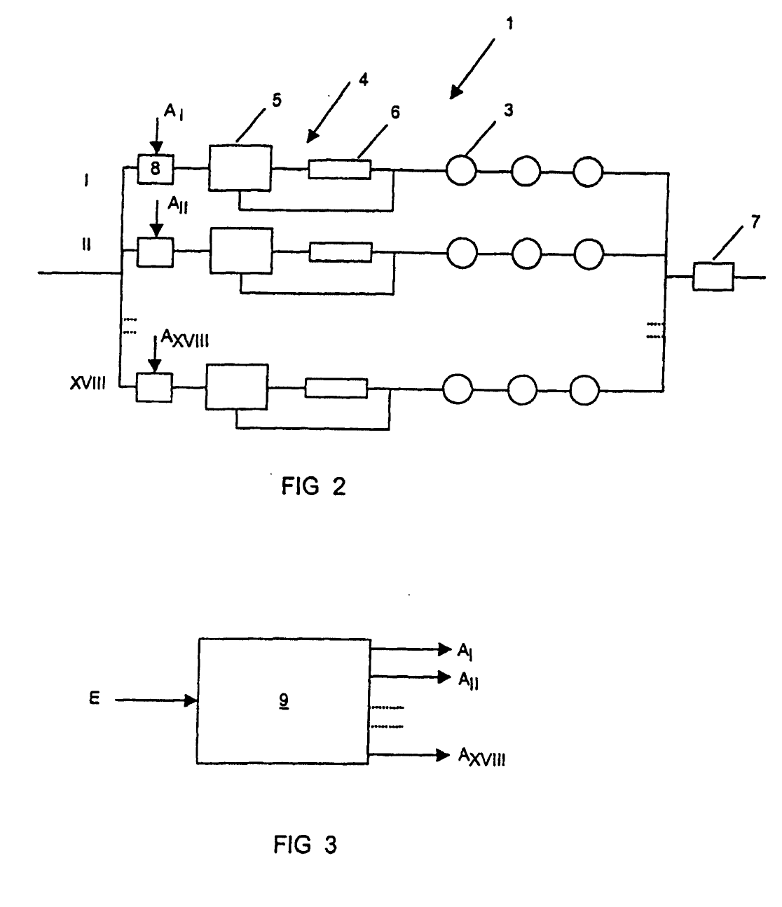

FIG. 2 shows an electrical circuit for the lamp from FIG. 1; and

FIG. 3 shows schematically a control device for the lamp from FIG. 1.

FIG. 1 shows a front view of a mining lamp 1. Visible is the light field 2 of the mining lamp 1, in which 54 light diodes 3 are arranged in a matrix of 8 columns and 7 rows. In the lowest row in FIG. 1 the outermost matrix points are not populated by light diodes. The light diodes 3 exhibit a separation distance from each other of 20 mm.

FIG. 2 shows an electrical circuit diagram of the mining lamp 1. Three light diodes 3 are each connected in series in a circuit leg I, II, . . . , XVIII. For the purposes of an overview only 3 of the total of 18 rows are shown in FIG. 2. The dotted lines are to indicate the circuit legs III to XVII that are not represented.

In each circuit leg I, II, . . . , XVIII a current regulator circuit 4 with a series regulator 5 and a resistance 6 is connected ahead of the light diodes 3. A device providing protection against polarity switching 7 ensures that the circuit is not damaged by any mistake concerning the voltage polarities.

Each circuit leg I, II, . . . , XVIII exhibits a module 8, by means of which the light diodes 3 arranged in the circuit leg in question are controlled by the control device 9 represented in FIG. 3. As a function of an input signal E the control device 9 generates output signals AI, AII, . . . , AXVIII, such that in each case the current flow for the circuit leg in question is regulated by means of the module 8.

1-19. (canceled)

20. A mining lamp with a signal display, wherein the mining lamp includes a large number of light diodes and a control device, by means of which the light diodes can be controlled individually or in groups in order to display symbols, flashing signals, letters, text, and/or patterns.

21. A mining lamp in accordance with claim 20, wherein the light diodes are arranged on a flat surface area.

22. A mining lamp in accordance with claim 21, wherein the light diodes are arranged in an even, generally symmetrical, pattern.

23. A mining lamp in accordance with claim 21, wherein the light diodes are arranged in the form of a matrix on the surface area.

24. A mining lamp in accordance with claim 23, wherein the surface area is approximately 150 mm×150 mm, such that the light diodes are arranged in seven or eight rows and also in seven or eight columns.

25. A mining lamp in accordance with claim 24, wherein at least two of the light diodes emit light of different colours.

26. A mining lamp in accordance with claim 24, wherein the light diodes controlled by the control device generate a scrolling text, such that a plurality alphanumeric symbols can be represented at the same time.

27. A mining lamp in accordance with claim 24, wherein at least about three light diodes are electrically connected together in series and a current regulator circuit including a series regulator and a resistance, the circuit being connected ahead of the light diodes that are connected in series.

28. A mining lamp in accordance with claim 20, wherein a main direction of radiation of at least two of the light diodes is different.

29. A mining lamp in accordance with claim 20, wherein at least two of the light diodes emit light of different colours.

30. A mining lamp in accordance with claim 20, wherein at least two of the light diodes exhibit light of different intensity.

31. A mining lamp in accordance with claim 20, wherein the light diodes controlled by the control device generate a scrolling text, such that a plurality of alphanumeric symbols can be represented at the same time.

32. A mining lamp in accordance with claim 20, wherein the mining lamp is operated between about 5 volts to about 12 volts.

33. A mining lamp in accordance with claim 32, wherein the mining lamp is operated at about 12 volts.

34. A mining lamp in accordance with claim 20, wherein at least about three light diodes are electrically connected together in series.

35. A mining lamp in accordance with claim 34, further comprising a current regulator circuit including a series regulator and a resistance, the circuit being ahead of the light diodes that are connected in series.

36. A mining lamp in accordance with claim 20, further comprising an inverse polarity protection device in communication with at least one of the light modes.

37. A mining lamp in accordance with claim 20, wherein the current for the mining lamp is 360 mA.

38. A mining lamp in accordance with claim 20, wherein the mining lamp is configured to connect to a bi-directional communication circuit.

39. A mining lamp in accordance with claim 20, further comprising a microcontroller in communication with the control device.
